(19) United States
(12) Patent Application Publication
(10) Pub. No.: US 2006/0032931 A1
(43) Pub. Date: Feb. 16, 2006

(54) Humidity control in a sealed housing

(76) Inventor: Neal F. Gunderson, Lake Elmo, MN (US)

Correspondence Address: Seagate Technology LLC, 1280 Disc Drive, Shakopee, MN, 55379, US

(21) Appl. No.: 10/915,085

(22) Filed: Aug. 10, 2004

(51) Int. Cl. F24F 3/14; G05D 22/02; F24F 11/00

(52) U.S. Cl. 236/44 A

(57) ABSTRACT

Method for providing relative humidity control in a sealed housing, and apparatus formed thereby. A water vapor emission assembly, such as a desiccant, is placed within a housing in a first gas atmosphere such as ambient air. The first gas atmosphere is subsequently replaced with a second gas atmosphere, such as an inert gas atmosphere (e.g., helium). The second gas atmosphere has an initial relative humidity less than a desired relative humidity. Upon replacement, water vapor from the water vapor emission assembly is emitted to achieve the desired relative humidity within the second gas atmosphere. The housing is preferably characterized as a housing of a data storage device.

### FIELD OF THE INVENTION

The claimed invention relates generally to the field of housing structures and more particularly, but not by way of limitation, to an apparatus and method for controlling a relative humidity level in an atmosphere retained within a sealed housing, such as a housing of a data storage device.

### BACKGROUND

Disc drives are digital data storage devices which store and retrieve large amounts of user data in a fast and efficient manner. A housing encloses one or more storage media and associated transducing heads which are used to write and subsequently retrieve the user data for a host device. The heads are typically supported adjacent the disc surfaces by fluidic pressures established by the high speed rotation of the discs.

It is generally desirable to control the internal atmospheric environment within the housing to ensure proper operation of the device. Contaminants within the internal atmosphere can corrode various surfaces and can otherwise interfere with the reading and writing of data. Breather and recirculation filters are thus often disposed within the housing to control such contaminants.

Efforts are also often made to control relative humidity levels within the internal atmosphere. As will be recognized, relative humidity is a ratio, usually expressed as a percentage, of the amount of water vapor in an atmosphere to the maximum amount that the atmosphere could hold for a given temperature. Too low a relative humidity can accelerate wear to the lubricated disc surfaces, as well as enhance the potential for electrostatic discharge damage to sensitive electronic components; too high a relative humidity can accelerate corrosion and increase static friction (stiction) between the heads and discs, thereby potentially preventing the device from being able to successfully start rotation of the discs.

Historically, data storage device housings have utilized ambient air for the internal operational environment. With continued demand for devices with ever higher data storage and transfer rate capabilities in smaller form factors, designers are increasingly evaluating other configurations, such as the use of inert gas environments (e.g., helium) instead of air.

Accordingly, there is a continued need for improvements in the art with regard to establishing relative humidity levels within a controlled atmosphere retained within a housing, such as but not limited to the housing of a data storage device.

### SUMMARY OF THE INVENTION

Preferred embodiments of the present invention are generally directed to a method comprising placing a water vapor emission assembly within a housing in a first gas atmosphere, and replacing the first gas atmosphere with a second gas atmosphere having an initial relative humidity less than a desired relative humidity. Thereafter, water vapor from the water vapor emission assembly is emitted to achieve the desired relative humidity within the second gas atmosphere.

Preferably, the first gas atmosphere comprises atmospheric air and the second gas atmosphere comprises an inert gas, such as helium at a selected concentration such as at least about 90%. The housing preferably comprises a housing of a data storage device.

In other preferred embodiments, an apparatus is provided comprising a sealed housing which retains an inert gas atmosphere and a water vapor emission assembly within the housing which emits water vapor into the inert gas atmosphere to substantially maintain a desired relative humidity within said housing, the apparatus formed by a process comprising placing the water vapor emission assembly within the housing in a first gas atmosphere, and replacing the first gas atmosphere with the inert gas atmosphere having an initial relative humidity less than the desired relative humidity. The water vapor from the water vapor emission assembly is emitted to achieve the desired relative humidity within the inert gas atmosphere.

These and various other features and advantages which characterize the claimed invention will become apparent upon reading the following detailed description and upon reviewing the associated drawings.

### BRIEF DESCRIPTION OF THE DRAWINGS

FIG. 1 is a top plan representation of a hermetically sealed data storage device with a housing which retains an internal inert gas atmosphere established in accordance with preferred embodiments of the present invention.

FIG. 2 is a side elevational view of the housing to more clearly illustrate a water vapor emission assembly of FIG. 1.

FIG. 3 shows a preferred water vapor emission assembly construction.

FIG. 4 shows an alternative preferred water vapor emission assembly construction.

FIG. 5 schematically depicts the housing to illustrate a preferred utilization of the water vapor emission assembly in conjunction with a replenishment assembly, a getter assembly and a filter assembly.

FIG. 6 provides a functional block diagram of a system utilized in accordance with preferred embodiments of the present invention to establish the internal gas atmosphere within the housing.

FIG. 7 is a flow chart for a DEVICE FABRICATION routine illustrative of steps carried out in accordance with preferred embodiments of the present invention.

### DETAILED DESCRIPTION

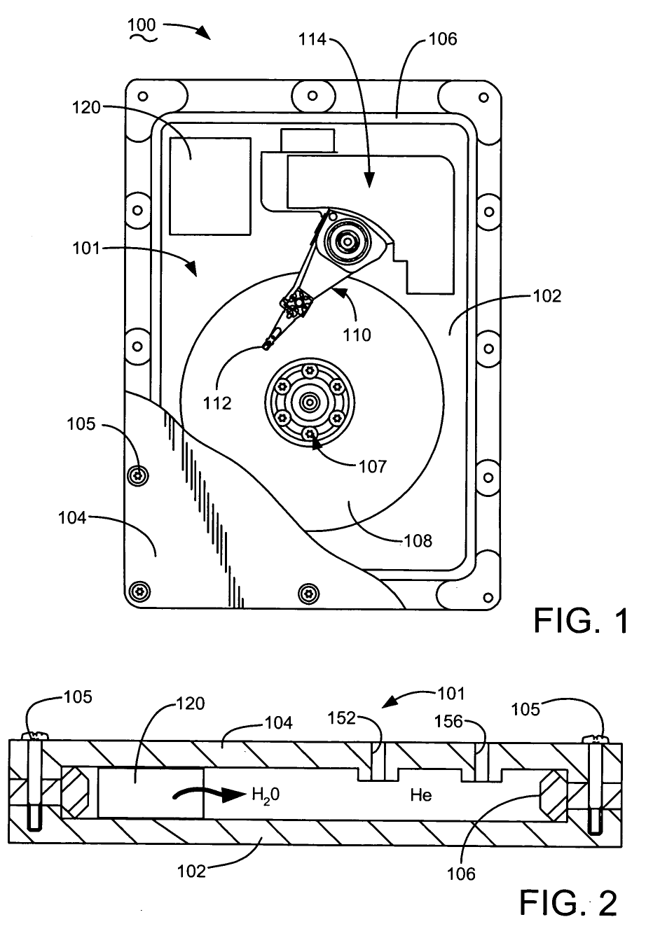

To illustrate an exemplary environment in which presently preferred embodiments of the present invention can be advantageously practiced, FIG. 1 shows a data storage device 100 of the type configured to store and retrieve digital data for a host device (not shown).

A hermetically sealed housing 101 encapsulates an inert gas atmosphere, preferably comprising helium at a concentration of at least about 90%. The housing is formed by a pair of substantially planar housing members including a base deck 102 and a top cover 104 (the latter of which is shown in partial cut-away in FIG. 1).

The top cover 104 is affixed to the base deck 102 via fasteners 105. A metal compression seal 106 is compressed between the base deck 102 and top cover 104 to effect a housing seal. Alternative methodologies for joining and sealing the base deck 102 and top cover 104 are readily envisioned, including the use of laser welding.

A spindle motor 107 is supported within the housing and rotates a number of recording media (discs) 108 at a constant high speed during operation. A rotary actuator 110 supports a corresponding number of data transducing heads 112 adjacent data recording surfaces of the discs 108.

The heads 112 are hydrodynamically supported adjacent the disc surfaces via recirculating fluidic currents in the inert gas atmosphere established by the high speed rotation of the discs 108. The actuator 110 is pivotally rotated through application of current to a voice coil motor (VCM) 114 to bring the heads 112 into alignment with data tracks defined on the disc surfaces.

Preferably, the device 100 employs a contact start/stop scheme so that, when the device 100 is deactivated, the heads 112 come to rest on texturized landing zones (not designated) on the discs 108 near the innermost diameter thereof. However, such is illustrative and not limiting in that other head load/unload methodologies can be readily employed as desired, such as the use of ramp surfaces onto which the heads are placed when the device 100 is deactivated.

The actuator 110 is latched in a latched position to retain the heads 112 over the landing zones, and the spindle motor 107 is brought to a stop. During subsequent activation of the device 100, the discs 108 are accelerated, the heads 112 “take off” and achieve hydrodynamic support over the landing zones, the actuator 110 is unlatched and the heads 112 are moved out over the disc surfaces.

It is desirable that the relative humidity (hereafter “RH” or simply “humidity”) of the inert gas atmosphere retained by the housing 101 be maintained at suitable levels to ensure proper operation of the transducer/media interfaces. As will be recognized, the RH at any given point is a function of temperature. In turn, the temperature will tend to change with regard to the operational state of the device; that is, I²R losses in the VCM 114, spindle motor 107 and other components will tend to elevate the internal temperature within the housing 101 during operation, and the device 100 will tend to return to an ambient temperature of the surrounding environment after being turned off.

Accordingly, a water vapor emission assembly 120 is provided to establish and maintain a desired RH range within the housing 101. As shown in FIG. 2, the assembly 120 operates to emit water vapor into the internal helium atmosphere to bring the RH to the desired level. Depending upon the configuration of the device 100, it is contemplated that a suitable range for the RH within the housing 101 could extend from about 5% to about 50% or more, with a particularly suitable range comprising from about 15% to about 35%.

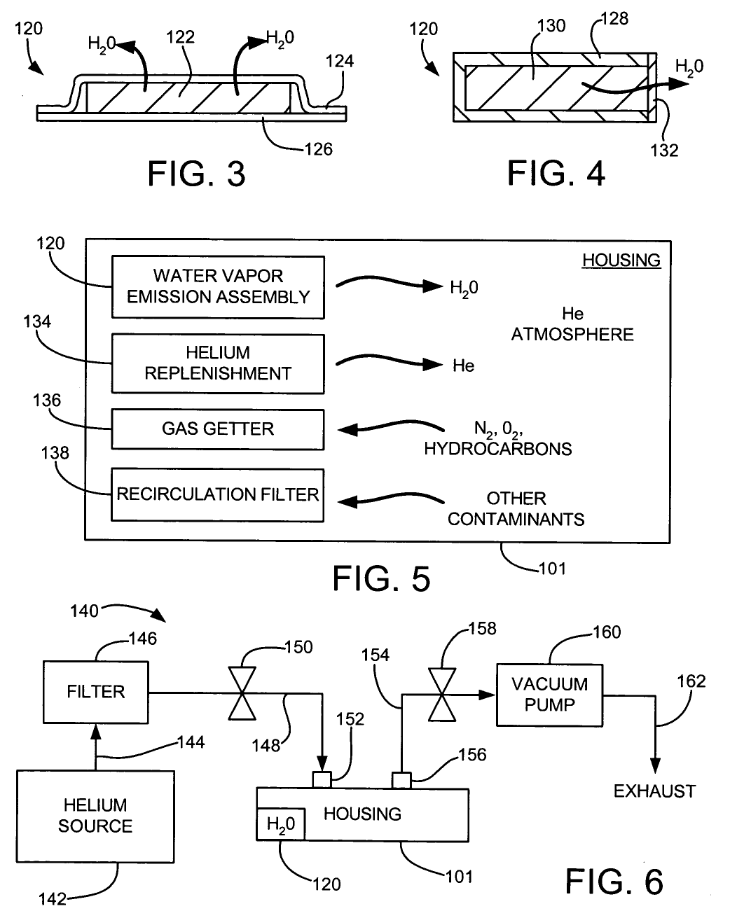

The assembly 120 can take a number of constructions. In FIG. 3, a suitable carbon or silica-based desiccant material 122 is encapsulated in opposing layers 124, 126 of a water vapor permeable material. Water vapor (H₂O) is initially adsorbed by the material 122 and subsequently released, as shown. In FIG. 4, a water vapor retaining canister 128 encases a suitable gel or other adsorptive material 130 from which the water vapor is emitted through a permeable wall 132. In another envisioned construction, the interior of the canister 128 in FIG. 4 can be filled with pressurized water and/or water vapor without the need for an underlying support structure.

The water vapor emission assembly 120 is preferably incorporated into a larger atmospheric control system, such as illustrated by FIG. 5. This system further utilizes a helium replenishment assembly 134 which supplies additional amounts of helium (or other inert gas matching the inert gas atmosphere of the housing 101) to account for leakage through the housing seal 106. A gas getter assembly 136 comprises a getter or other adsorptive material specially suited to attract certain types of undesired gas molecules such as nitrogen (N₂), oxygen (O₂), hydrocarbons, etc. A recirculation filter 138 entraps other contaminants such as fluid-borne particulates from the atmosphere. Each of these assemblies are well known to those skilled in the art, so further discussion with regard to the particular constructions of these assemblies is unnecessary.

Preferred methodologies in which the water vapor emission assembly 120 is advantageously employed will now be discussed. As will be recognized, conventional device manufacturing processes in which ambient air atmospheres are utilized in the final assembled devices do not generally pose a significant problem when it comes to establishing appropriate RH levels within the device housings. The devices are typically assembled in clean rooms or other controlled atmospheric environments, and the humidity is set to an appropriate level such as about 30% to about 50% to reduce the potential of damage due to electrostatic discharge (ESD), to reduce degradation of the transducer/media interfaces, etc.

During such conventional manufacturing processes, the housing is often “open” to the surrounding atmosphere as the various internal components are installed (spindle motor, discs, actuator, etc.). The top cover is then installed onto the base deck to enclose the housing.

It follows, then, that the initial gas atmosphere inside the housing at this point has substantially the same makeup as the surrounding environment, since installation of the top cover simply “entraps” or “appropriates” a portion of the surrounding environment into the sealed housing.

This initial RH level may or may not correspond to the long term desired RH value for the device. For example, when the desired RH value is lower than the initial value (e.g., 35% instead of 50%), designers have advantageously included adsorptive materials to remove an appropriate amount of humidity from the internal atmosphere to bring the internal RH to the desired level.

A problem arises, however, when a different atmosphere is desired as compared to that environment in which the device is assembled. Consider the device 100 which utilizes a helium environment; generally, it is not deemed to be particularly desirable to assemble the device 100 in a helium environment while the housing 101 is open, and then simply appropriate a portion of that environment for the internal atmosphere when the housing is sealed, as before.

Rather, it is contemplated that an atmospheric replacement approach may be more economically and technically feasible. In the proposed approach, existing manufacturing processes can be used to assemble the drive in an air atmosphere, followed by a replacement of the initial atmosphere with the final desired atmosphere (in this case, helium).

This approach brings additional concerns, however. As is well recognized, ambient air is an admixture of a number of different gasses of which oxygen makes up about 21%, and in which water vapor generally makes up at least some portion. It is relatively straightforward to filter ambient air to the requisite cleanliness from a contamination standpoint and to remove or introduce appropriate additional levels of water vapor to achieve the desired humidity level (e.g., 50%).

By contrast, commercially available pressurized helium generally does not include substantial amounts of water vapor, and hence typically has a very low RH (i.e., is typically relatively “dry”). It has also been found to be generally difficult to control the amounts of water vapor and hence RH of highly pressurized helium from a source. Accordingly, the aforementioned water vapor emission assembly advantageously facilitates the introduction of the helium atmosphere into the housing 101 and achieves the desired RH level after the replacement operation, as will now be described.

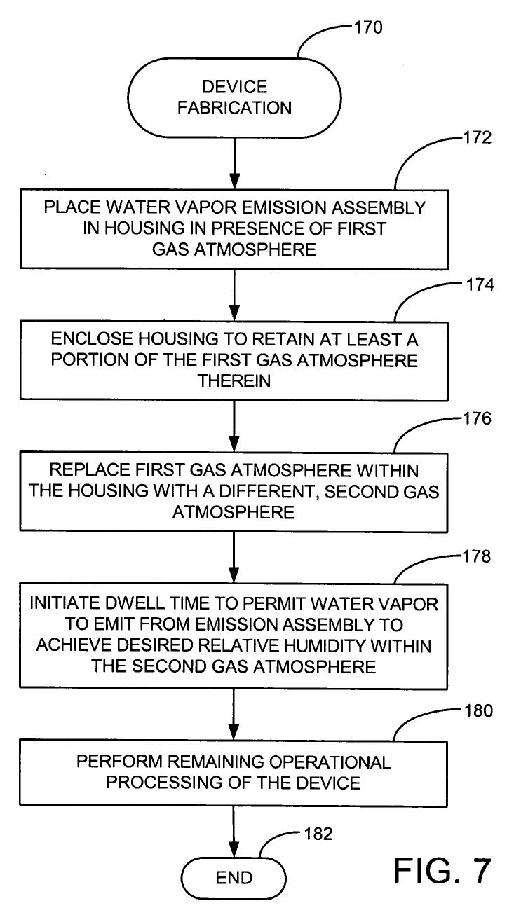

FIG. 6 provides a schematic illustration of an atmospheric replacement system 140 which, in accordance with preferred embodiments, operates to establish the internal helium environment of the housing 101 of FIG. 1.

A helium source 142 provides a source of pressurized helium for introduction into the device housing 101. As mentioned above, it is contemplated that this pressurized helium has a relatively low RH (such as less than about 5%). A conduit 144 ports the pressurized helium through a filter 146 to filter out undesired contaminants, providing filtered helium via inlet conduit 148 with on-off flow control valve 150. The conduit 148 is preferably configured to interface with a sealable port opening 152 in the housing (depicted in FIG. 2 in an open position for clarity).

The system 140 further includes a second outlet conduit 154 configured to interface with a second sealable port opening 156 in the housing 101. The outlet conduit 154 likewise includes an on-off flow control valve 158 and communicates with a vacuum pump 160. The outlet flow from the pump 160 is conveyed along conduit 162 to an exhaust sink, which can comprise the surrounding atmosphere or a sealed receiving vessel (not shown).

The system 140 is preferably utilized during the fabrication of the device 100 in accordance with the flow of FIG. 7, which provides a DEVICE FABRICATION routine 170. At step 172, the water vapor emission assembly 120 is placed within the housing 101 in the presence of a first gas atmosphere. Preferably, this is carried out in an automated manufacturing process as described above, so that the first gas atmosphere comprises an ambient air atmosphere of a surrounding clean room or similar environment. This first gas atmosphere preferably has an initial RH of about 50%. Other components of the device 100, such as the spindle motor 107, discs 108, actuator 110, VCM 114, etc. are also installed into the housing 101 during this step (i.e., onto the base deck 102).

The housing 101 is next preferably enclosed at step 174, which is accomplished in the present example by attachment of the top cover 104 to the base deck via fasteners 105 to compress the seal 106. At the conclusion of this step, at least a portion of the first gas atmosphere has been appropriated and sealed into the sealed housing 101; that is, the sealed housing 101 retains an ambient air atmosphere at about 50% RH.

At step 176, the first gas atmosphere is replaced with a different, second gas atmosphere having a relative humidity less than a desired level. As previously mentioned, this second gas atmosphere preferably comprises helium, although such is not limiting. The system 140 of FIG. 6 is utilized during this step 176, preferably as follows.

1. Outlet conduit 154 is coupled via port 156 to communicate with the interior of the housing 101.

2. Valve 158 is opened and pump 160 evacuates the first gas atmosphere from the interior of the housing.

3. Inlet conduit 148 is coupled via port 152 to communicate with the interior of the housing 101.

4. Valve 150 is opened, permitting flow of the pressurized helium from the source 142 into the housing 101. As desired, the valve 158 and the pump 160 can be operable during a portion of this time to effect further evacuation of the molecules from the first atmosphere, or valve 158 can be closed and pump 160 can be turned off prior to the introduction of the helium into the housing 101.

5. Once the desired amount of helium has flowed into the housing 101, valve 150 is closed and conduits 148, 154 are removed from the housing. Ports 152, 156 are closed to retain the housing 101 in a sealed condition.

It will be noted that the foregoing atmospheric replacement operation can be advantageously carried out in a relatively fast manner. Depending on the various factors relating to the configuration of the device 100 and the system 140, the entire operation is envisioned as being carried out within 60 seconds or less, and preferably within 10 seconds or less.

It will further be noted that various alternative configurations to the system of FIG. 6 could readily be made, such as the use of a positive pressure pump to direct the inlet helium into the housing 101, an accumulator to accumulate a preselected amount of helium for flow into the housing, the use of a single conduit that connects to the housing along which the evacuated gas and the inlet gas are successively directed, the use of sensors and other feedback controls, etc.

Preferably, the replacement operation of step 176 results in a complete removal of substantially all of the molecules from the first gas atmosphere in order to achieve the desired concentration of new molecules in the second, replacement gas atmosphere. However, in other preferred embodiments a greater amount of residual molecules from the first gas atmosphere may be acceptable for inclusion into the second gas atmosphere.

Accordingly, for clarity it will be understood that the term “replacing” in this context will require removal of at least 50% of the molecules from the first gas atmosphere from the housing, allowing the second gas atmosphere to include the remainder as part of said second atmosphere.

Continuing with the flow of FIG. 7, the process continues to step 178 wherein a dwell time is provided during which water vapor from the water vapor emission assembly is emitted into the helium atmosphere within the housing to achieve the desired RH therein (such as the aforementioned 15% to 35% range). It is contemplated that this dwell time may take as little as just a few minutes or tens of minutes before equilibrium is achieved. Remaining processing of the device 100 is thereafter carried out at step 180, including appropriate operational testing of the device, after which the process ends at step 182.

Preferably, the dwell time of step 178 comprises a time during which the device 100 is non-operational (to prevent damage that could be incurred, for example, by spinning up the discs 108 in a low RH environment). This does not mean that the device 100 necessarily needs to be left alone or otherwise held in a stationary position during the emission of the water vapor. Thus, additional non-operational steps, such as the attachment of printed circuit boards, labels, etc. could readily be performed during the dwell time of step 178.

It will now be clear the various preferred embodiments discussed herein provide several advantages over the prior art. Rapid filling of the new gaseous environment can be made without concern for the initial internal RH of the inlet gas, which allows commercially available helium (or other gasses) to be used without the need for modification thereof. The disclosed embodiments further facilitate high volume throughput rates in an automated environment.

The amount of water vapor provided in the water vapor emission assembly can be empirically determined to provide the optimum amounts of vapor for a given application. It is further envisioned that, depending on the construction of the assembly, regulation of the RH levels may further be provided by the assembly to match changes in operational temperature of the device so that the assembly both emits and adsorbs water vapor as necessary to maintain the RH levels in the desired ranges.

While the various preferred embodiments discussed herein have been directed to a hermetically sealed data storage device that retains an inert gas atmosphere, it will be understood that such is not limiting to the scope of the claimed subject matter. Rather the claimed subject matter extends to any number of applications, including medical systems, in which a sealed housing has a first atmosphere which is replaced with a second atmosphere, irrespective of whether the second atmosphere comprises inert gas.

Moreover, while the various preferred embodiments discussed herein have been directed to a data storage device that utilizes a contact start-stop (CSS) methodology, it will be recognized that the foregoing advantages are similarly obtained for devices that utilize ramp surfaces or other head load/unload schemes.

Accordingly, preferred embodiments of the present invention are generally directed to a method (such as 170) comprising placing a water vapor emission assembly (such as 120) within a housing (such as 101) in a first gas atmosphere (such as by step 172), and replacing the first gas atmosphere with a second gas atmosphere having an initial relative humidity less than a desired relative humidity (such as by step 176), wherein water vapor from the water vapor emission assembly is subsequently emitted to achieve the desired relative humidity within the second gas atmosphere (such as by step 178).

Preferably, the first gas atmosphere comprises atmospheric air and the second gas atmosphere comprises an inert gas, such as helium at a selected concentration. The housing preferably comprises a housing of a data storage device (such as 100).

In other preferred embodiments, an apparatus (such as 100) is provided comprising a sealed housing (such as 101) which retains an inert gas atmosphere and a water vapor emission assembly (such as 120) within the housing which emits water vapor into the inert gas atmosphere to substantially maintain a desired relative humidity within said housing, the apparatus formed by a process comprising placing the water vapor emission assembly within the housing in a first gas atmosphere (such as by step 172), and replacing the first gas atmosphere with the inert gas atmosphere having an initial relative humidity less than the desired relative humidity (such as by step 176), wherein the water vapor from the water vapor emission assembly is emitted to achieve the desired relative humidity within the inert gas atmosphere (such as by step 178).

For purposes of the appended claims, the term “replacing” will be defined as requiring the removal of at least 50% of the molecules from the first gas atmosphere from the housing, so that the recited second gas atmosphere can include the remainder as part of said second atmosphere.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application of the housing without departing from the spirit and scope of the present invention.

In addition, although the embodiments described herein are directed to the replenishment of an inert gas atmosphere within a data storage device, it will be appreciated by those skilled in the art that the claimed subject matter is not so limited and various other housing applications and atmospheric compositions can be utilized without departing from the spirit and scope of the claimed invention.

What is claimed is:

1. A method comprising:
placing a water vapor emission assembly within a housing in a first gas atmosphere; and
replacing the first gas atmosphere with a different, second gas atmosphere having an initial relative humidity less than a desired relative humidity, wherein water vapor from the water vapor emission assembly is subsequently emitted to achieve the desired relative humidity within the second gas atmosphere.

2. The method of claim 1, wherein the first gas atmosphere comprises atmospheric air with a selected concentration of water vapor to provide a first relative humidity.

3. The method of claim 2, wherein the first relative humidity of the first gas atmosphere is at least about 30%.

4. The method of claim 1, wherein the desired relative humidity achieved during the replacing step is selected from a range of about 5% to about 50%.

5. The method of claim 1, wherein the second gas atmosphere of the replacing step comprises an inert gas.

6. The method of claim 5, wherein the inert gas comprises helium at a concentration of at least about 90%.

7. The method of claim 1, wherein the replacing step comprises a step of using a vacuum pump to evacuate the first gas atmosphere from the housing so that the housing is characterized as an evacuated housing.

8. The method of claim 7, wherein the replacing step further comprises a subsequent step of flowing the second gas atmosphere into the evacuated housing.

9. The method of claim 8, wherein the using and flowing steps are carried out over a combined elapsed time of less than about 60 seconds.

10. The method of claim 1, wherein the housing is characterized as a housing of a data storage device in which a transducer/medium interface is disposed.

11. The method of claim 10, further comprising a prior step of operating the transducer/medium interface in said first gas atmosphere.

12. The method of claim 10, wherein the desired relative humidity achieved during the replacing step is selected to reduce damage to the transducer/medium interface.

13. The method of claim 11, wherein the placing step further comprises placing a gas getter assembly within the housing configured to subsequently collect contaminating gas particles from said second gas atmosphere.

14. The method of claim 1, wherein the placing step further comprises placing a gas replenishment assembly within the housing to subsequently introduce additional molecules of said second gas atmosphere into the housing.

15. The method of claim 1, further comprising a step of hermetically sealing the housing after the placing step and prior to the replacing step.

16. The method of claim 1, wherein the replacing step comprises removing at least 50% of the molecules in the first atmosphere within the housing and introducing selected gas molecules into the housing so that the different, second gas atmosphere comprises said selected gas molecules and the remaining molecules from the first atmosphere.

17. The method of claim 1, wherein the replacing step comprises removing at least substantially all of the molecules of the first atmosphere from the housing and then introducing selected gas molecules into the housing so that the different, second gas atmosphere comprises said selected gas molecules in combination with no residual molecules from the first atmosphere or a relatively small number of residual molecules from the first atmosphere.

18. A data storage device formed in accordance with the method of claim 1.

19. An apparatus comprising a sealed housing which retains an inert gas atmosphere and a water vapor emission assembly within the housing which emits water vapor into the inert gas atmosphere to substantially maintain a desired relative humidity within said housing, the apparatus formed by a process comprising placing the water vapor emission assembly within the housing in a first gas atmosphere, and replacing the first gas atmosphere with the inert gas atmosphere having an initial relative humidity less than the desired relative humidity, wherein the water vapor from the water vapor emission assembly is emitted to achieve the desired relative humidity within the inert gas atmosphere.

20. The apparatus of claim 19, wherein the first gas atmosphere comprises atmospheric air with a selected concentration of water vapor to provide a first relative humidity.

21. The apparatus of claim 20, wherein the first relative humidity of the first gas atmosphere is at least about 30%.

22. The apparatus of claim 19, wherein the desired relative humidity achieved during the replacing step is selected from a range of about 5% to about 50%.

23. The apparatus of claim 19, wherein the second gas atmosphere of the replacing step comprises an inert gas.

24. The apparatus of claim 23, wherein the inert gas comprises helium at a concentration of at least about 90%.

25. The apparatus of claim 19, wherein the housing is characterized as a housing of a data storage device in which a transducer/medium interface is disposed.

26. The apparatus of claim 19, wherein the placing step further comprises placing a gas getter assembly within the housing configured to subsequently collect contaminating gas particles from said second gas atmosphere.

27. The apparatus of claim 19, wherein the placing step further comprises placing a gas replenishment assembly within the housing to subsequently introduce additional molecules of said second gas atmosphere into the housing.

28. The apparatus of claim 19, further comprising a step of hermetically sealing the housing after the placing step and prior to the replacing step.
